(19) United States
(12) Patent Application Publication
(10) Pub. No.: US 2023/0361347 A1
(43) Pub. Date: Nov. 9, 2023

(54) ADDITIVE, AND LITHIUM SECONDARY BATTERY ELECTROLYTE AND LITHIUM SECONDARY BATTERY, WHICH COMPRISE SAME

(71) Applicant: SAMSUNG SDI CO., LTD., Yongin-si, Gyeonggi-do (KR)

(72) Inventors: Tae Jin LEE, Yongin-si (KR); Dahyun KIM, Yongin-si, (KR); Minseo KIM, Yongin-si, (KR); Sanghoon KIM, Yongin-si, (KR); Taehoon KIM, Yongin-si, (KR); Bongjin MOON, Yongin-si, (KR); Myungheui WOO, Yongin-si, (KR); Wonseok CHO, Yongin-si, (KR); Sanghyung KIM, Yongin-si (KR); Hyejin PARK, Yongin-si (KR); Bokyung RYU, Yongin- (KR)

(21) Appl. No.: 18/044,971

(22) PCT Filed: Nov. 17, 2021
(86) PCT No.: PCT/KR2021/016923

§ 371 Date: Mar. 10, 2023

(30) Foreign Application Priority Data
Nov. 25, 2020 (KR) 10-2020-0160280

(51) Int. Cl. H01M 10/0567; H01M 4/525; H01M 4/485; H01M 10/0568; H01M 4/505; H01M 10/052

(52) U.S. Cl. CPC H01M 10/0567; H01M 4/485; H01M 4/505; H01M 4/525; H01M 10/052; H01M 10/0568; H01M 2004/028

(57) ABSTRACT

Provided are an additive represented by Chemical Formula 1, an electrolyte for a lithium secondary battery including the same, and a lithium secondary battery. Details of Chemical Formula 1 are the same as those described in the specification.

### TECHNICAL FIELD

This disclosure relates to an additive, an electrolyte for a lithium secondary battery and a lithium secondary battery.

### BACKGROUND ART

A lithium secondary battery may be recharged and has three or more times as high energy density per unit weight as a conventional lead storage battery, nickel-cadmium battery, nickel hydrogen battery, nickel zinc battery and the like and may be also charged at a high rate and thus, is commercially manufactured for a laptop, a cell phone, an electric tool, an electric bike, and the like, and researches on improvement of additional energy density have been actively made.

Such a lithium secondary battery is manufactured by injecting an electrolyte into a battery cell, which includes a positive electrode including a positive electrode active material capable of intercalating/deintercalating lithium ions and a negative electrode including a negative electrode active material capable of intercalating/deintercalating lithium ions.

Particularly, the electrolyte uses an organic solvent in which a lithium salt is dissolved, and such an electrolyte is important in determining stability and performance of a lithium secondary battery.

LiPF₆, which is most commonly used as a lithium salt of the electrolyte, has a problem of accelerating the depletion of the solvent and generating a large amount of gas by reacting with the organic solvent of the electrolyte. When LiPF₆ decomposes, LiF and PF₅ are produced, which causes electrolyte depletion in the battery, resulting in high-temperature performance degradation and poor safety.

Accordingly, there is a demand for an electrolyte with improved safety without performance deteriorate even at high-temperature condition.

### DISCLOSURE

### Technical Problem

An embodiment provides additive having improved thermal stability.

Another embodiment provides a lithium secondary battery with improved cycle-life characteristics, high-temperature safety, and high-temperature reliability by applying the additive, and in particular, improved high-temperature storage characteristics and penetration safety by reducing gas generation and resistance increase rate during high-temperature storage.

Another embodiment provides lithium secondary battery including the electrolyte for the lithium secondary battery.

### Technical Solution

An embodiment of the present invention provides an additive represented by Chemical Formula 1.

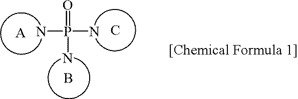

In Chemical Formula 1,

A, B, and C are each independently a substituted or unsubstituted nitrogen-containing heterocyclic group.

The nitrogen contained in the A, B, and C are each linked to P═O group by a sigma bond.

The A, B, and C may each independently be a substituted or unsubstituted nitrogen-containing aromatic heterocyclic group or a substituted or unsubstituted nitrogen-containing non-aromatic heterocyclic group.

The substituted or unsubstituted nitrogen-containing aromatic heterocyclic group may be a substituted or unsubstituted pyrrolyl group, a substituted or unsubstituted pyrazolyl group, a substituted or unsubstituted imidazolyl group, a substituted or unsubstituted triazolyl group, a substituted or unsubstituted oxazine group, a substituted or unsubstituted thiazine group, a substituted or unsubstituted benzimidazolyl group, a substituted or unsubstituted indolyl group, a substituted or unsubstituted isoindolyl group, a substituted or unsubstituted benzoxazinyl group, a substituted or unsubstituted benzthiazinyl group, a substituted or unsubstituted phenothiazinyl group, or a substituted or unsubstituted phenoxazinyl group.

The substituted or unsubstituted nitrogen-containing non-aromatic heterocyclic group may be a substituted or unsubstituted 2-pyrroline group, a substituted or unsubstituted 3-pyrroline group, a substituted or unsubstituted pyrrolidine group, a substituted or unsubstituted pyrazolidine group, a substituted or unsubstituted imidazolidine group, a substituted or unsubstituted piperidine group, a substituted or unsubstituted piperazine group, a substituted or unsubstituted morpholine group, a substituted or unsubstituted thiomorpholine group, a substituted or unsubstituted dithiazine group, a substituted or unsubstituted indoline group, or a substituted or unsubstituted isoindoline group.

The A, B, and C may each independently be a substituted or unsubstituted pyrrolidine group, a substituted or unsubstituted piperidine group, a substituted or unsubstituted pyrrolyl group, a substituted or unsubstituted pyrazolyl group, a substituted or unsubstituted imidazolyl group, or a substituted or unsubstituted benzimidazolyl group.

The A, B, and C may each independently be selected from the substituents listed in Group 1.

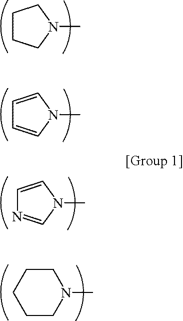

Another embodiment of the present invention provides an electrolyte for a lithium secondary battery including a non-aqueous organic solvent, a lithium salt, and the aforementioned additive.

The additive may be included in an amount of 0.1 wt% to 10 wt% based on the total weight of the electrolyte for the lithium secondary battery.

The additive may be included in an amount of 0.1 wt% to 5.0 wt% based on the total weight of the electrolyte for the lithium secondary battery.

The additive may be included in an amount of 0.1 wt% to 3.0 wt% based on the total weight of the electrolyte for the lithium secondary battery.

Another embodiment of the present invention provides a lithium secondary battery including a positive electrode including a positive electrode active material; a negative electrode including a negative electrode active material; and the aforementioned electrolyte.

The positive electrode active material may be a lithium composite oxide represented by Chemical Formula 4.

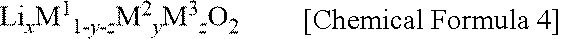

In Chemical Formula 4, 0.5≤×≤1.8, 0≤y≤1, 0≤z≤1, 0≤y+z<1, and M¹, M², and M³ each independently may be any one selected from metals such as Ni, Co, Mn, Al, Sr, Mg, or La, and a combination thereof.

For example, the positive electrode active material may be a lithium composite oxide represented by at least one of Chemical Formula 4-1 to Chemical Formula 4-3.

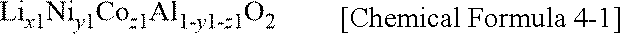

In Chemical Formula 4-1,

1≤x1≤1.2, 0<y1<1, and 0<z1<1.

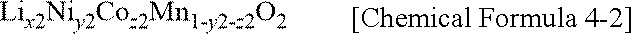

In Chemical Formula 4-2,

1≤x2≤1.2, 0<y2<1, and 0<z2<1.

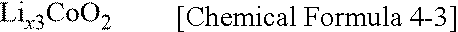

In Chemical Formula 4-3,

0.5< x3 ≤1.

### Advantageous Effects

By applying the additive with improved thermal safety, an increase in internal resistance and generation of gas after being left at a high temperature and a voltage drop may be suppressed and thus a lithium secondary battery with improved high-temperature characteristics and penetration safety may be implemented.

### DESCRIPTION OF THE DRAWINGS

FIG. 1 is a schematic view showing a lithium secondary battery according to an embodiment of the present invention.

FIG. 2 is a ¹H-NMR graph of the compound of Chemical Formula a.

FIG. 3 is ¹³C-NMR graph of the compound of Chemical Formula a.

FIG. 4 is ³¹P-NMR graph of the compound of Chemical Formula a.

FIG. 5 is a graph showing temperature and voltage changes according to heat exposure for lithium secondary battery cells according to Examples 1 to 3 and Comparative Examples 1 and 2.

FIG. 6 is a graph showing changes in cell surface temperature and cell voltage after penetration of 150 mm/s for lithium secondary battery cells of Examples 1 to 3 and Comparative Examples 1 and 2.

FIG. 7 is a graph measuring CID (current interrupt device) operation time points of lithium secondary battery cells according to Examples 1 to 3 and Comparative Examples 1 and 2.

FIG. 8 is a graph showing room-temperature charge and discharge cycle characteristics of the lithium secondary battery cells according to Examples 1 to 3 and Comparative Examples 1 and 2.

FIG. 9 is a graph showing a resistance increase rate and a capacity recovery rate measured after the lithium secondary battery cells according to Examples 1 to 3 and Comparative Examples 1 and 2 were left at 60° C. for 30 days.

<Description of Symbols>
100: lithium secondary battery
112: negative electrode
113: separator
114: positive electrode
120: battery case
140: sealing member

### MODE FOR INVENTION

Hereinafter, a lithium secondary battery according to an embodiment of the present invention will be described in details with reference to the accompanying drawings. However, these embodiments are exemplary, the present invention is not limited thereto and the present invention is defined by the scope of claims.

A lithium secondary battery may be classified into a lithium ion battery, a lithium ion polymer battery, and a lithium polymer battery depending on kinds of a separator and an electrolyte. It also may be classified to be cylindrical, prismatic, coin-type, pouch-type, and the like depending on shapes. In addition, it may be bulk type and thin film type depending on sizes. Structures and manufacturing methods for lithium ion batteries pertaining to this disclosure are well known in the art.

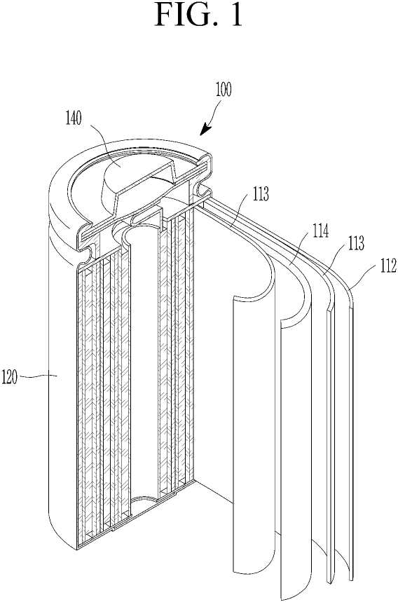

Here, a cylindrical lithium secondary battery will be described as an example of a lithium secondary battery. FIG. 1 schematically illustrates a structure of a lithium secondary battery according to an embodiment.

Referring to FIG. 1, a lithium secondary battery 100 according to an embodiment includes a battery cell including a positive electrode 114, a negative electrode 112 facing the positive electrode 114, and a separator 113 between the positive electrode 114 and the negative electrode 112, an electrolyte (not shown) impregnating a positive electrode 114, a negative electrode 112, and the separator 113, a battery container 120 containing the battery cell, and a sealing member 140 for sealing the container 120.

In the present specification, when a definition is not otherwise provided, “substituted” refers to replacement of at least one hydrogen in a substituent or a compound by deuterium, a halogen group, a hydroxyl group, an amino group, a substituted or unsubstituted C1 to C30 amine group, a nitro group, a substituted or unsubstituted C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 trifluoroalkyl group, a cyano group, or a combination thereof.

In one example of the present invention, “substituted” refers to replacement of at least one hydrogen of a substituent or a compound by deuterium, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, or a C2 to C30 heteroaryl group. In addition, in specific examples of the present invention, “substituted” refers to replacement of at least on hydrogen of a substituent or a compound by deuterium, a C1 to C20 alkyl group, or a C6 to C30 aryl group. In addition, in specific examples of the present invention, “substituted” refers to replacement of at least one hydrogen of a substituent or a compound by deuterium, a C1 to C5 alkyl group, or a C6 to C18 aryl group. In addition, in specific examples of the present invention, “substituted” refers to replacement of at least one hydrogen of a substituent or a compound by deuterium, a methyl group, a ethyl group, a propyl group, a butyl group, a phenyl group, a biphenyl group, a terphenyl group or a naphthyl group.

In the present specification, when a definition is not otherwise provided, “hetero” refers to one including one to three heteroatoms selected from N, O, S, P, and Si, and remaining carbons in one functional group.

In the present specification, “a heterocyclic group” has a generic concept of an aromatic heterocyclic group and non-aromatic heterocyclic group and may include at least one heteroatom selected from N, O, S, P, and Si instead of carbon (C) in a cyclic compound such as an aryl group, a cycloalkyl group, a fused ring thereof, or a combination thereof. When the heterocyclic group is a fused ring, the entire ring or each ring of the heterocyclic group may include one or more heteroatoms.

For example, “an aromatic heterocyclic group” refers to an aryl group including at least one heteroatom selected from N, O, S, P, and Si. Two or more heteroaryl groups are linked by a sigma bond directly, or when the heteroaryl group includes two or more rings, the two or more rings may be fused. When the heteroaryl group is a fused ring, each ring may include one to three heteroatoms.

In the present specification, “sigma bond” refers to a bond in which orbitals formed along an axis of bonding to the nucleus of an atom are overlapped with each other in parallel to form a strong bond. That is, it means forming a single bond directly between atoms.

Hereinafter, an additive according to an embodiment will be described.

An additive according to an embodiment of the present invention is represented by Chemical Formula 1.

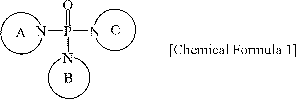

In Chemical Formula 1,

A, B, and C are each independently a substituted or unsubstituted nitrogen-containing heterocyclic group,

The nitrogen contained in the A, B, and C are each linked to P═O group by a sigma bond.

The additive according to an embodiment of the present invention has a structure in which three nitrogen-containing heterocycles containing N are substituted in ‘P’ of a phosphine oxide group (P═O), wherein the ‘P’ and the ‘N’ are linked by the sigma bond.

The ‘N’ linked by the sigma bond to the ‘P’ of the phosphine oxide group (P=O) has a lone pair of electrons, and since the lone pair of electrons capable of chelating during the exposure to a high temperature may chelate HF to trap the HF and in addition, may chelate PF₅, a strong Lewin acid, as a decomposition product of lithium salt to stabilize it, thereby suppressing an additional side reaction.

In addition, the lone pair of electrons helps to stabilize the surface of the positive electrode by chelating transition metals of the positive electrode active material.

The additive forms each film on the surfaces of the positive and negative electrodes during the formation, thereby suppressing an increase in electrode/electrolyte interface resistance during the storage at a high temperature and also, suppressing gas generation due to an additional side reaction of the electrolyte at the high temperature. In addition, the additive remaining in the electrolyte without forming the film forms an additional insulation film on the surface of the positive electrode during the exposure at a high temperature and thus exhibits an effect of improving thermal safety characteristics. In particular, these structures form a thick insulation film on the negative electrode during the formation, which may block electrons accumulated in the negative electrode from escaping even when a battery is penetrated, suppressing ignition due to a short circuit of the battery.

For example, the A, B, and C may each independently be a substituted or unsubstituted nitrogen-containing aromatic heterocyclic group or a substituted or unsubstituted nitrogen-containing non-aromatic heterocyclic group.

For example, the substituted or unsubstituted nitrogen-containing aromatic heterocyclic group may be a substituted or unsubstituted pyrrolyl group, a substituted or unsubstituted pyrazolyl group, a substituted or unsubstituted imidazolyl group, a substituted or unsubstituted triazolyl group, a substituted or unsubstituted oxazine group, a substituted or unsubstituted thiazie group, a substituted or unsubstituted benzimidazolyl group, a substituted or unsubstituted indolyl group, a substituted or unsubstituted isoindolyl group, a substituted or unsubstituted benzoxazinyl group, a substituted or unsubstituted benzthiazinyl group, a substituted or unsubstituted phenothiazinyl group, or a substituted or unsubstituted phenoxazinyl group.

For example, the substituted or unsubstituted nitrogen-containing non-aromatic heterocyclic group may be a substituted or unsubstituted 2-pyrroline group, a substituted or unsubstituted 3-pyrroline group, a substituted or unsubstituted pyrrolidine group, a substituted or unsubstituted pyrazolidine group, a substituted or unsubstituted imidazolidine group, a substituted or unsubstituted piperidine group, a substituted or unsubstituted piperazine group, a substituted or unsubstituted morpholine group, a substituted or unsubstituted thiomorpholine group, a substituted or unsubstituted dithiazine group, a substituted or unsubstituted indoline group, or a substituted or unsubstituted isoindoline group.

For example, the A, B, and C may each independently be a substituted or unsubstituted pyrrolidine group, a substituted or unsubstituted piperidine group, a substituted or unsubstituted pyrrolyl group, a substituted or unsubstituted pyrazolyl group, a substituted or unsubstituted imidazolyl group, or a substituted or unsubstituted benzimidazolyl group.

As a specific example, the A, B, and C may each independently be selected from the substituents listed in Group 1.

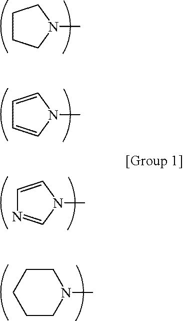

The A, B, and C may be the same as or different from each other.

For example, each of the A, B, and C may be a substituted or unsubstituted imidazolyl group.

According to the most specific embodiment, the additive may be represented by Chemical Formula a.

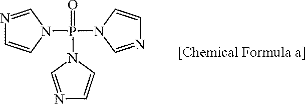 [SMILES: O=P(n1ccnc1)(n1ccnc1)n1ccnc1]

An electrolyte for a lithium secondary battery according to another embodiment of the present invention includes a non-aqueous organic solvent, a lithium salt, and the aforementioned additive.

The additive may be included in an amount of 0.1 wt% to 10 wt%, specifically, 0.1 wt% to 5.0 wt%, and more specifically, 0.1 wt% to 3.0 wt% based on the total weight of the electrolyte for the lithium secondary battery.

When the additive is included within the content ranges, a lithium secondary battery with improved penetration safety and high-temperature reliability may be realized by preventing the increase in resistance at a high temperature.

In other words, when the additive is included in an amount of less than 0.1 wt%, there is a problem of deteriorating high-temperature storage characteristics, and when the additive is included in an amount of greater than 10 wt%, there is another problem of deteriorating a cycle-life due to an increase in interface resistance.

The non-aqueous organic solvent serves as a medium for transmitting ions taking part in the electrochemical reaction of a battery.

The non-aqueous organic solvent may be a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, t-butyl acetate, methylpropionate, ethylpropionate, propylpropionate, decanolide, mevalonolactone, caprolactone, and the like

The ether-based solvent may include dibutyl ether, tetraglyme, diglyme, dimethoxyethane, 2-methyltetrahydrofuran, tetrahydrofuran, and the like. In addition, the ketone-based solvent may be cyclohexanone and the like. The alcohol-based solvent may include ethanol, isopropyl alcohol, and the like and the aprotic solvent may include nitriles such as R-CN (wherein R is a hydrocarbon group having a C2 to C20 linear, branched, or cyclic structure and may include a double bond, an aromatic ring, or an ether bond), and the like, dioxolanes such as 1,3-dioxolane, and the like, sulfolanes, and the like.

The non-aqueous organic solvent may be used alone or in a mixture of one or more, and when one or more are mixed and used, the mixing ratio may be appropriately adjusted according to the desired battery performance, which is widely understood by those in the art.

The carbonate-based solvent is prepared by mixing a cyclic carbonate and a linear carbonate. In this case, when the cyclic carbonate and the chain carbonate are mixed in a volume ratio of 1:1 to 1:9, the electrolyte may exhibit excellent performance.

The non-aqueous organic solvent may further include an aromatic hydrocarbon-based organic solvent in addition to the carbonate-based solvent. In this case, the carbonate-based solvent and the aromatic hydrocarbon-based solvent may be mixed in a volume ratio of 1:1 to 30:1.

The aromatic hydrocarbon-based solvent may be an aromatic hydrocarbon-based compound represented by Chemical Formula 2.

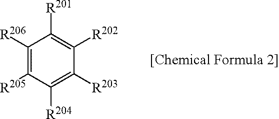

In Chemical Formula 2, R²⁰¹ to R²⁰⁶ are the same or different and are selected from hydrogen, a halogen, a C1 to C10 alkyl group, a haloalkyl group, and a combination thereof.

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylene carbonate, vinyl ethylene carbonate, or an ethylene carbonate-based compound represented by Chemical Formula 3 in order to improve cycle-life of a battery.

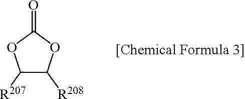

In Chemical Formula 3, R²⁰⁷ and R²⁰⁸ are the same or different and selected from hydrogen, a halogen, a cyano group (CN), a nitro group (NO₂), and a fluorinated C1 to C5 alkyl group, provided that at least one of R²⁰⁷ and R²⁰⁸ is a halogen, a cyano group (CN), a nitro group (NO₂), and a fluorinated C1 1 to C5 alkyl group and R²⁰⁷ and R²⁰⁸ are not simultaneously hydrogen.

Examples of the ethylene-based carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving cycle-life may be used within an appropriate range.

The lithium salt dissolves in a non-aqueous organic solvent and acts as a source of lithium ions in the battery to enable basic operation of the lithium secondary battery and promotes movement of lithium ions between the positive electrode and the negative electrode. Examples of the lithium salt may include at least one selected from LiPF₆, LiBF₄, lithium difluoro(oxalate)borate (LiDFOB), LiPO₂F₂, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide): LiFSI), LiC₄F₉SO₃, LiClO₄, LiAlO₂, LiAlCl₄, LiN(CₓF₂ₓ₊₁SO₂)(C_{y}F_{2y+1}SO₂) (wherein x and y are natural numbers, for example, an integer ranging from 1 to 20), LiCl, Lil, and LiB(C₂O₄)₂ (lithium bis(oxalato) borate: LiBOB). The lithium salt may be used in a concentration ranging from 0.1 M to 2.0 M. When the lithium salt is included at the above concentration range, an electrolyte may have excellent performance and lithium ion mobility due to optimal electrolyte conductivity and viscosity.

Another embodiment of the present invention provides a lithium secondary battery including a positive electrode including a positive electrode active material; a negative electrode including a negative electrode active material; and the aforementioned electrolyte.

The positive electrode includes a positive electrode current collector and a positive electrode active material layer formed on the positive electrode current collector, and the positive electrode active material layer includes a positive electrode active material.

The positive electrode active material may include a lithiated intercalation compound that reversibly intercalates and deintercalates lithium ions.

Specifically, at least one of a composite oxide of lithium and a metal selected from cobalt, manganese, nickel, and a combination thereof may be used.

Of course, one having a coating layer on the surface of the lithium composite oxide may be used, or a mixture of the composite oxide and a compound having a coating layer may be used. The coating layer may include at least one coating element compound selected from an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by using these elements in the compound and for example, the method may include any coating method (e.g., spray coating, dipping, etc.), but is not illustrated in more detail since it is well-known to those skilled in the related field.

The positive electrode active material may be, for example, at least one of lithium composite oxides represented by Chemical Formula 4.

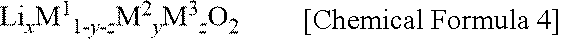

In Chemical Formula 4,

0.5≤x≤1.8, 0≤y<1, 0≤z<1, 0≤y+z<1, and M¹, M², and M³ are each independently any one selected from a metal such as Ni, Co, Mn, Al, Sr, Mg, or La, and a combination thereof.

In an embodiment, M¹ may be a metal such as Co, Mn, Al, Sr, Mg, or La, and M² and M³ may each independently be Ni or Co.

In a specific embodiment, M¹ may be Mn or Al, and M² and M³ may each independently be Ni or Co, but they are not limited thereto.

In a more specific embodiment, the positive electrode active material may be a lithium composite oxide represented by at least one of Chemical Formula 4-1 to Chemical Formula 4-3.

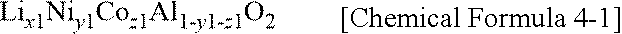

In Chemical Formula 4-1, 1≤x1≤1.2, 0<y1<1, and 0<z1<1.

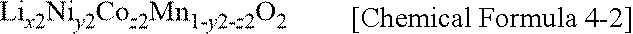

In Chemical Formula 4-2,

1≤x2≤1.2, 0<y2<1, and 0<z2<1.

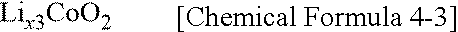

In Chemical Formula 4-3,

0.5< x3 ≤1.

For example, in Chemical Formula 4-1, 1≤x1≤1.2, 0.5≤y1<1, and 0<z1≤0.5.

As a specific example, in Chemical Formula 4-1, 1≤x1≤1.2, 0.6≤y1 <1, and 0<z1≤0.5.

As a more specific example, in Chemical Formula 4-1, 1≤x1≤1.2, 0.7≤y1<1, and 0<z1≤0.5.

For example, in Chemical Formula 4-1, 1≤x1≤1.2, 0.8≤y1<1, and 0<z1≤0.5.

For example, in Chemical Formula 4-2, 1≤x2≤1.2, 0.3≤y2<1, and 0.3≤z2<1.

As a specific example, in Chemical Formula 4-2, 1≤x2≤1.2, 0.6<y2<1, and 0.3≤z2<1.

As a more specific example, in Chemical Formula 4-2, 1≤x2≤1.2, 0.7≤y2<1, and 0.3≤z2<1.

For example, in Chemical Formula 4-2, 1≤x2≤1.2, 0.8≤y2<1, and 0.3≤z2<1.

A content of the positive electrode active material may be 90 wt% to 98 wt% based on the total weight of the positive electrode active material layer.

In an embodiment of the present invention, the positive electrode active material layer may optionally include a conductive material and a binder. In this case, a content of the binder may be 1 wt% to 5 wt% based on the total weight of the positive electrode active material layer.

Each content of the conductive material and the binder may be 1 wt% to 5 wt% based on the total weight of the positive electrode active material layer.

The conductive material is used to impart conductivity to the positive electrode, and may be used as long as it is an electron conductive material without causing chemical change in the battery and examples of the conductive material may include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The binder improves binding properties of positive electrode active material particles with one another and with a current collector and examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The positive electrode current collector may include Al, but is not limited thereto.

The negative electrode includes a negative electrode current collector and a negative electrode active material layer including a negative electrode active material formed on the negative electrode current collector.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon material, the carbon material may be any generally-used carbon-based negative electrode active material in a lithium secondary ion battery, and examples thereof may be crystalline carbon, amorphous carbon, or a mixture thereof. The crystalline carbon may be non-shaped, or sheet, flake, spherical, or fiber shaped natural graphite or artificial graphite and the amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be Si, Si-C composite, SiOₓ (0 < x < 2), a Si-Q alloy wherein Q is an element selected from an alkali metal, an alkaline-earth metal, a Group 13 element, a Group 14 element, a Group 15 element, a Group 16 element, a transition metal, a rare earth element, and a combination thereof, but not Si), Sn, SnO₂, Sn-R (wherein R is an element selected from an alkali metal, an alkaline-earth metal, a Group 13 element, a Group 14 element, a Group 15 element, a Group 16 element, a transition metal, a rare earth element, and a combination thereof, but not Sn), and the like and at least one of these materials may be mixed with SiO₂.

The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The transition metal oxide may be vanadium oxide, lithium vanadium oxide, or lithium titanium oxide.

In a specific embodiment, the negative electrode active material may be a Si—C composite including a Si-based active material and a carbon-based active material.

An average particle diameter of the Si-based active material in the Si-C composite may be 50 nm to 200 nm.

When the average particle diameter of the Si-based active material is within the above range, volume expansion occurring during charging and discharging may be suppressed, and a break in a conductive path due to particle crushing during charging and discharging may be prevented.

The Si-based active material may be included in an amount of 1 wt% to 60 wt%, for example, 3 wt% to 60 wt% based on the total weight of the Si-C composite.

In another specific embodiment, the negative electrode active material may further include crystalline carbon together with the aforementioned Si-C composite.

When the negative electrode active material includes a Si—C composite and crystalline carbon together, the Si—C composite and crystalline carbon may be included in the form of a mixture, and in this case, the Si—C composite and crystalline carbon may be included in a weight ratio of 1:99 to 50:50. More specifically, the Si—C composite and crystalline carbon may be included in a weight ratio of 5 : 95 to 20 : 80.

The crystalline carbon may be, for example, graphite, and more specifically natural graphite, artificial graphite, or a mixture thereof.

An average particle diameter of the crystalline carbon may be 5 µm to 30 µm.

In the present specification, the average particle diameter may be a particle size (D50) at 50% by volume in a cumulative size-distribution curve.

The Si—C composite may further include a shell surrounding a surface of the Si—C composite, and the shell may include amorphous carbon.

The amorphous carbon may include soft carbon, hard carbon, mesophase pitch carbonized product, calcined coke, or a mixture thereof.

The amorphous carbon may be included in an amount of 1 to 50 parts by weight, for example, 5 to 50 parts by weight, or 10 to 50 parts by weight, based on 100 parts by weight of the carbon-based active material.

In the negative electrode active material layer, the negative electrode active material may be included in an amount of 95 wt% to 99 wt% based on the total weight of the negative electrode active material layer.

In an embodiment of the present invention, the negative electrode active material layer includes a binder, and optionally a conductive material. In the negative electrode active material layer, a content of the binder may be 1 wt% to 5 wt% based on the total weight of the negative electrode active material layer. When the negative electrode active material layer includes a conductive material, the negative electrode active material layer includes 90 wt% to 98 wt% of the negative electrode active material, 1 wt% to 5 wt% of the binder, and 1 wt% to 5 wt% of the conductive material.

The binder improves binding properties of negative electrode active material particles with one another and with a current collector. The binder includes a non-water-soluble binder, a water-soluble binder, or a combination thereof.

The non-water-soluble binder may be selected from polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The water-soluble binder may be a rubber-based binder or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. The polymer resin binder may be selected from polytetrafluoroethylene, ethylenepropylenecopolymer, polyethyleneoxide, polyvinylpyrrolidone, polyepichlorohydrine, polyphosphazene, polyacrylonitrile, polystyrene, an ethylenepropylenediene copolymer, polyvinylpyridine, chlorosulfonated polyethylene, latex, a polyester resin, an acrylic resin, a phenolic resin, an epoxy resin, polyvinyl alcohol, and a combination thereof.

When the water-soluble binder is used as a negative electrode binder, a cellulose-based compound may be further used to provide viscosity. The cellulose-based compound includes one or more of carboxymethyl cellulose, hydroxypropylmethyl cellulose, methyl cellulose, or alkali metal salts thereof. The alkali metals may be Na, K, or Li. Such a thickener may be included in an amount of 0.1 to 3 parts by weight based on 100 parts by weight of the negative electrode active material.

The conductive material is included to provide electrode conductivity and any electrically conductive material may be used as a conductive material unless it causes a chemical change and examples of the conductive material may include a carbon-based material such as natural graphite, artificial graphite, carbon black, acetylene black, ketjen black, a carbon fiber, and the like; a metal-based material of a metal powder or a metal fiber including copper, nickel, aluminum silver, and the like; a conductive polymer such as a polyphenylene derivative; or a mixture thereof.

The negative electrode current collector may be selected from a copper foil, a nickel foil, a stainless steel foil, a titanium foil, a nickel foam, a copper foam, a polymer substrate coated with a conductive metal, and a combination thereof.

A separator may exist between the positive electrode and the negative electrode depending on the type of the lithium secondary battery. The separator may be a porous substrate; or a composite porous substrate.

The porous substrate may be a substrate including pores, through which lithium ions can move. The porous substrate is for example include polyethylene, polypropylene, polyvinylidene fluoride or and multi-layers thereof such as a polyethylene/polypropylene double-layered separator, a polyethylene/polypropylene/polyethylene triple-layered separator, a polypropylene/polyethylene/polypropylene triple-layered separator, and the like.

The composite porous substrate may have a form including a porous substrate and a functional layer on the porous substrate. The functional layer may be, for example, at least one of a heat-resistant layer and an adhesive layer from the viewpoint of enabling additional function. For example, the heat-resistant layer may include a heat-resistant resin and optionally a filler.

In addition, the adhesive layer may include an adherence resin and selectively a filler.

The filler may be organic filler or an inorganic filler.

Referring to FIG. 1, a lithium secondary battery 100 according to an embodiment includes a battery cell including a negative electrode 112, a positive electrode 114 facing the negative electrode 112, a separator 113 between the negative electrode 112 and the positive electrode 114, and an electrolyte (not shown) impregnating the negative electrode 112, the positive electrode 114, and the separator 113, a battery case 120 housing the battery cell, and a sealing member 140 sealing the battery case 120.

Hereinafter, examples of the present invention and comparative examples are described. These examples, however, are not in any sense to be interpreted as limiting the scope of the invention.

### Synthesis of Additives

### Synthesis Example: Compound of Chemical Formula a

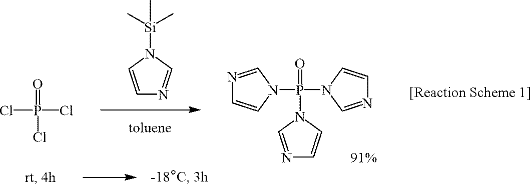

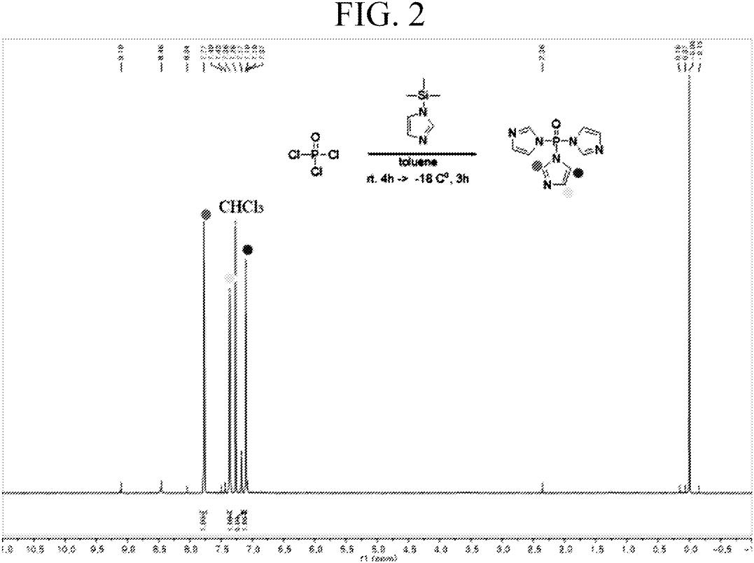

The compound of Chemical Formula a was confirmed from NMR analysis data according to FIGS. 2 to 4.

FIG. 2 is a ¹H-NMR graph of the compound of Chemical Formula a.

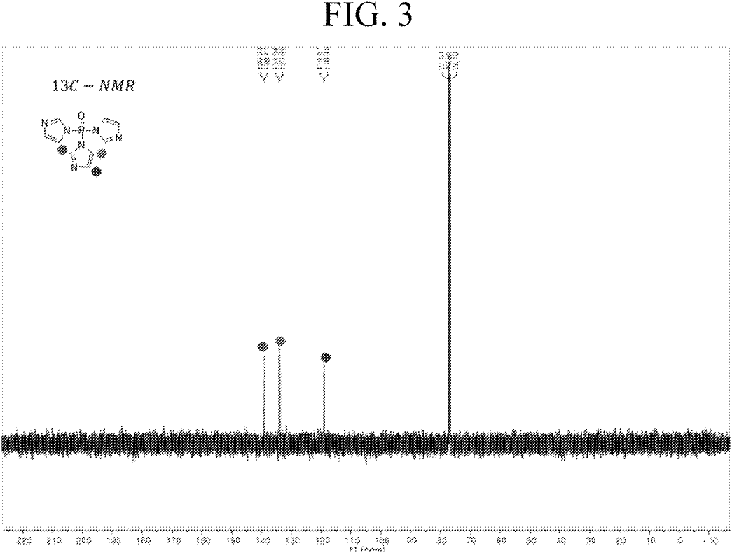

FIG. 3 is a ¹³C-NMR graph of the compound of Chemical Formula a.

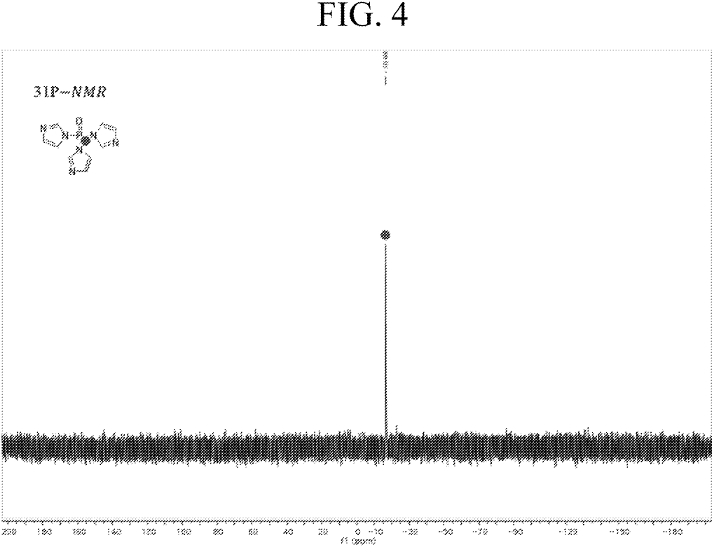

FIG. 4 is a ³¹P-NMR graph of the compound of Chemical Formula a.

### Manufacture of Lithium Secondary Battery Cell

### Example 1

Positive electrode active material slurry was prepared by using LiNi_{0.91}Mno_{0.07}Al_{0.02}O₂ as a positive electrode active material, polyvinylidene fluoride as a binder, and ketjen black as a conductive material in a weight ratio of 97:2:1 and dispersing the mixture in N-methyl pyrrolidone.

The positive electrode active material slurry was coated on a 14 µm-thick Al foil, dried at 110° C., and pressed to manufacture a positive electrode.

A negative electrode active material was prepared by mixing artificial graphite and an Si—C composite in a weight ratio of 93:7, and then the negative electrode active material, a styrene-butadiene rubber binder, and carboxylmethyl cellulose were mixed in a weight ratio of 97:1:2 and then, dispersed in distilled water to prepare negative electrode active material slurry.

The Si—C composite included a core including artificial graphite and silicon particles, and a coal-based pitch coated on the surface of the core.

The negative electrode active material slurry was coated on a 10 µm-thick Cu foil, dried at 100° C., and pressed to manufacture a negative electrode.

An electrode assembly was manufactured by assembling the manufactured positive and negative electrodes, and a separator made of polyethylene having a thickness of 25 µm, and an electrolyte was injected to manufacture a lithium secondary battery cell.

The electrolyte has a following composition.
(Composition of Electrolyte)
Salt: 1.5 M LiPF₆
Solvent: ethylene carbonate: ethylmethyl carbonate: dimethyl carbonate (EC: EMC:DMC= volume ratio of 20:10:70)
Additive: a composition including 0.5 wt% of the compound of Chemical Formula according to the synthesis example
(in the composition of the electrolyte, “wt%” is based on the total content of the electrolyte (lithium salt + non-aqueous organic solvent + additive.)

### Example 2

A lithium secondary battery cell was manufactured in the same manner as in Example 1 except that the compound represented by Chemical Formula a was added in an amount of 1.0 wt%.

### Example 3

A lithium secondary battery cell was manufactured in the same manner as in Example 1 except that the compound represented by Chemical Formula a was added in an amount of 2.0 wt%.

### Comparative Example 1

A lithium secondary battery cell was manufactured in the same manner as in Example 1 except that an electrolyte not including the additive was used.

### Comparative Example 2

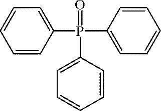 [SMILES: O=P(c1ccccc1)(c1ccccc1)c1ccccc1]

A lithium secondary battery cell was manufactured in the same manner as in Example 1 except that triphenylphosphine oxide (CAS No. 791-28-6) manufactured by Sigma Sigma-Aldrich Corp. was used in an amount of 1.0 wt%.

### Evaluation 1: Thermal Exposure Evaluation

The lithium secondary battery cells according to Examples 1 to 3 Comparative Examples 1 and 2 were charged under a 4.2 V/3 hr cut-off condition at a 0.5 C charge rate in a 3.0 V discharge state and then, evaluated with respect to thermal exposure.

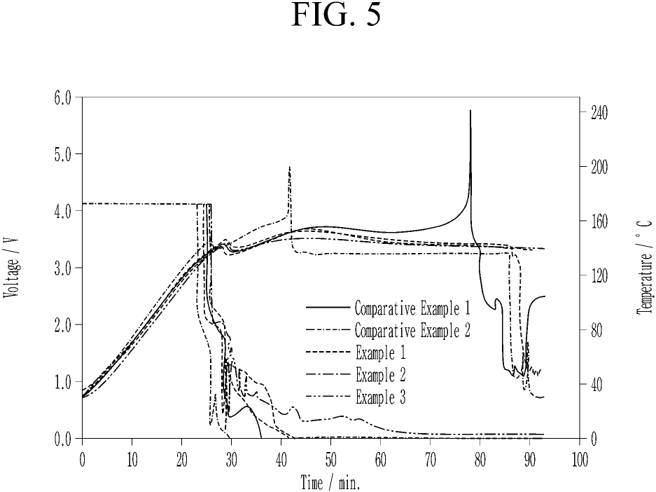

The lithium secondary battery cells according to Examples 1 to 3 and Comparative Examples 1 and 2 were placed in a chamber and heated from room temperature to 140° C. at a rate of 5° C./min and then, examined with respect to changes thereof, while maintained at the temperature for 1 hour, and the results are shown in FIG. 5. In this case, the dotted line represents the voltage change with time, and the solid line represents the temperature change with time.

FIG. 5 is a graph showing temperature and voltage changes according to heat exposure for lithium secondary battery cells according to Examples 1 to 3 and Comparative Examples 1 and 2.

Referring to FIG. 5, a sharp voltage drop was observed in the lithium secondary batter cells according to Examples 1 to 3 and Comparative Examples 1 and 2. When a cylindrical battery is rapidly exposed to a high temperature, gas is generated and thus increases internal pressure, which may work as a battery protective circuit (CID), making it impossible to read a voltage. The sharp voltage drop in the lithium secondary battery cells according to Examples 1 to 3 and Comparative Examples 1 and 2 occurred by a protective circuit operated by gas generation due to the exposure to a high temperature.

However, even though the lithium secondary battery cells according to Examples 1 to 3 were exposed to a temperature of 140° C., the cells did not undergo thermal runaway, while maintaining the temperature of 140° C., but when the lithium secondary battery cells of Comparative Examples 1 and 2 were exposed to the temperature of 140° C., the cells seemed to maintain the temperature of 140° C. but respectively underwent sharp thermal runaway to 240° C. (78 minutes) and 200° C. (42 minutes). Accordingly, the lithium secondary battery cells of Comparative Examples 1 and 2 did not only generate gas but also underwent thermal runaway, thereby exploding.

Accordingly, the lithium secondary battery cells according to Examples 1 to 3 exhibited higher thermal stability than the lithium secondary battery cells of Comparative Examples 1 and 2.

### Evaluation 2: Evaluation of Penetration Safety

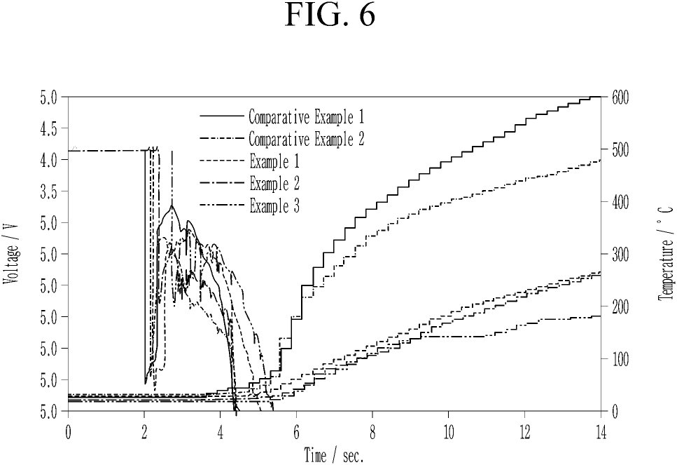

The lithium secondary battery cells according to Examples 1 to 3 and Comparative Examples 1 and 2 were evaluated with respect to penetration characteristics in the following method, and the results are shown in FIG. 6.

The penetration limit evaluation was performed by charging the cells to SOC (state of charge) 50 (capacity equivalent to a half of a total capacity of 100), using a 2.5 pi nail at 150 mm/s, and attaching a temperature sensor and a voltage sensor on the cell surface, obtaining a voltage or a temperature profile during the penetration.

FIG. 6 is a graph showing changes in cell surface temperature and cell voltage after penetration of 150 mm/s for lithium secondary battery cells of Examples 1 to 3 and Comparative Examples 1 and 2.

In the lithium secondary battery cells of Examples 1 to 3 and Comparative Examples 1 and 2, a voltage thereof was decreased to 0 V, which shows that the penetration caused positive and negative electrode short circuits. Herein, the cells generated a spark due to the short circuits and were highly likely to ignite. When the positive/negative electrodes contacted each other due to the penetration and thus generated a short circuit, the lithium secondary battery cells of Comparative Examples 1 and 2 generated a spark and ignited, increasing a battery temperature to 480° C. or higher, but the lithium secondary battery cells of Examples 1 to 3 generated a spark due to the short circuits but maintained the temperature at less than 300° C. without ignition. In other words, the lithium secondary battery cells of the examples, even though the positive and negative electrodes contacted each other and had short circuits, did not ignite, which shows that the cells had excellent thermal stability.

### Evaluation 3: Measurement of CID Operation Time Point

The lithium secondary battery cells of Examples 1 to 3 and Comparative Examples 1 and 2 were charged for 3 hours in a 4.35 V CC/CV mode at a charge/discharge rate of 0.5 C, and then left in a chamber at 90° C. for 20 hours to operate CID (current interrupt device) time point was measured.

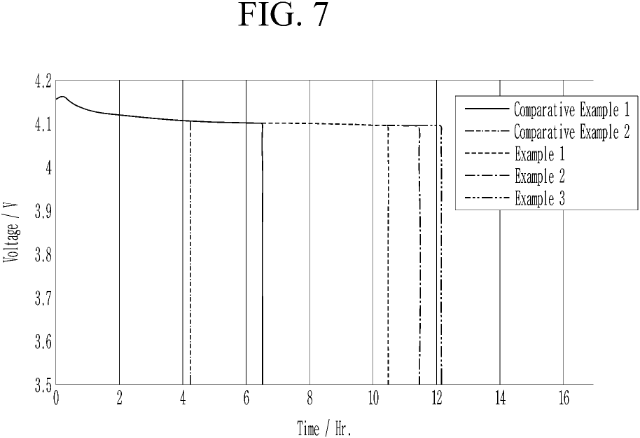

Herein, the CID (Current Interrupt Device) is an element detecting a pressure change, that is, a pressure increase in a sealed device and cutting off a current at a predetermined pressure or higher in the art and thus will not be illustrated in details here. The measurement results are shown in FIG. 7.

FIG. 7 is a graph measuring CID (current interrupt device) operation time points of lithium secondary battery cells according to Examples 1 to 3 and Comparative Examples 1 and 2.

By measuring the CID operation time point, the high-temperature storage characteristics of the lithium secondary battery can be evaluated.

Referring to FIG. 7, Comparative Examples 1 and 2 exhibited a sharp voltage drop before about 8 hours, when stored at a high temperature of 90° C., but in the examples including the additive according to an example embodiment of the present invention, a voltage drop was at least 10 hours or more delayed, which postponed the decomposition of an electrolyte and reduced the resistance insistence, having an effect of delaying an OCV drop. In other words, the lithium secondary battery cells according to the present invention had an excellent effect of suppressing gas generation when stored at a high temperature.

### Evaluation 4: Evaluation of Room-temperature Charge and Discharge Cycle Characteristics

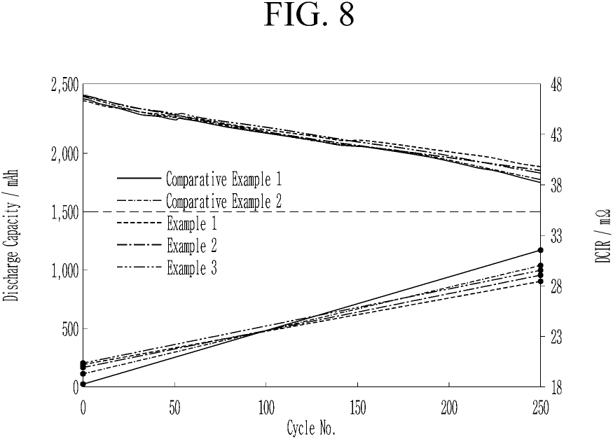

The lithium secondary battery cells according to Examples 1 to 3 and Comparative Examples 1 and 2 were charged and discharged and then, evaluated with respect to cycle characteristics, and the results are shown in FIG. 8.

While 250 cycles charged and discharged at a 0.5 C C-rate within 2.5 V to 4.2 V at 25° C., the cells were examined with respect to discharge capacity changes and DC-IR (direct current internal resistance) changes, and the results are shown in FIG. 8.

FIG. 8 is a graph showing room-temperature charge and discharge cycle characteristics of the lithium secondary battery cells according to Examples 1 to 3 and Comparative Examples 1 and 2.

Referring to FIG. 8, Examples 1 to 3 exhibited better cycle-life characteristics than Comparative Examples 1 and 2, and the degree of increase in internal resistance was also improved.

### Evaluation 5: Evaluation of Storage Characteristics at High Temperature

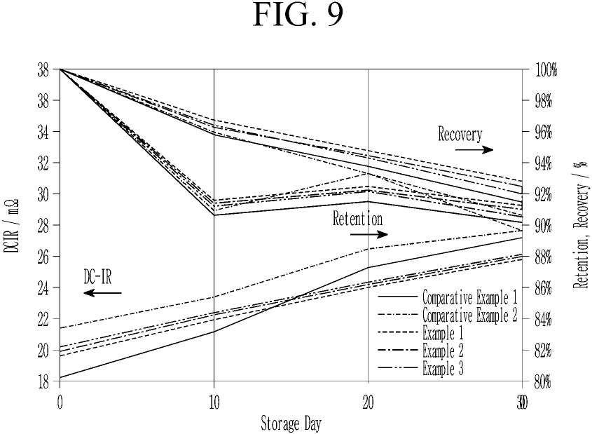

The lithium secondary battery cells according to Examples 1 to 3 and Comparative Examples 1 and 2 were stored under the following conditions and measured with respect to internal resistance and capacity retention, and the results are shown in FIG. 9.

After storage at high temperature (60° C.) for 10 days, direct current internal resistance (DC-IR) was measured at SOC 50 under 0.5 C rate discharge conditions.

In addition, with respect to each of the lithium secondary battery cells manufactured according to Examples 1 to 3 and Comparative Examples 1 and 2, the discharge capacity was measured. Subsequently, after stored at an interval of 10 days at a high temperature of 60° C., the cells were twice charged and discharged at 0.2 C and twice measured with respect to discharge capacity. Each ratio of discharge capacity after stored at a high temperature to discharge capacity before stored at the high temperature was calculated, wherein the first discharge capacity ratio was obtained as capacity retention, and the second discharge capacity ratio was obtained as recovery capacity.

FIG. 9 is a graph showing a resistance increase rate and a capacity recovery rate measured after the lithium secondary battery cells according to Examples 1 to 3 and Comparative Examples 1 and 2 were left at 60° C. for 30 days.

Referring to FIG. 9, in the case of Examples 1 to 3, compared to Comparative Examples 1 and 2, high-temperature storage characteristics are more improved.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

1. An additive represented by Chemical Formula 1: 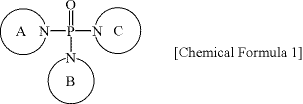
wherein, in Chemical Formula 1,
A, B, and C are each independently a substituted or unsubstituted nitrogen-containing heterocyclic group, and
the nitrogen contained in A, B, and C are each linked to P═O group by a sigma bond.

2. The additive of claim 1, wherein
A, B, and C are each independently a substituted or unsubstituted nitrogen-containing aromatic heterocyclic group or a substituted or unsubstituted nitrogen-containing non-aromatic heterocyclic group, additive
.

3. The additive of claim 2, wherein
the substituted or unsubstituted nitrogen-containing aromatic heterocyclic group is
a substituted or unsubstituted pyrrolyl group, a substituted or unsubstituted pyrazolyl group, a substituted or unsubstituted imidazolyl group, a substituted or unsubstituted triazolyl group, a substituted or unsubstituted oxazine group, a substituted or unsubstituted thiazine group, a substituted or unsubstituted benzimidazolyl group, a substituted or unsubstituted indolyl group, a substituted or unsubstituted isoindolyl group, a substituted or unsubstituted benzoxazinyl group, a substituted or unsubstituted benzthiazinyl group, a substituted or unsubstituted phenothiazinyl group, or a substituted or unsubstituted phenoxazinyl group.

4. The additive of claim 2, wherein
the substituted or unsubstituted nitrogen-containing non-aromatic heterocyclic group is
a substituted or unsubstituted 2-pyrroline group, a substituted or unsubstituted 3-pyrroline group, a substituted or unsubstituted pyrrolidine group, a substituted or unsubstituted pyrazolidine group, a substituted or unsubstituted imidazolidine group, a substituted or unsubstituted piperidine group, a substituted or unsubstituted piperazine group, a substituted or unsubstituted morpholine group, a substituted or unsubstituted thiomorpholine group, a substituted or unsubstituted dithiazine, a substituted or unsubstituted indoline group, or a substituted or unsubstituted isoindoline group.

5. The additive of claim 1, wherein
the A, B, and C are each independently a substituted or unsubstituted pyrrolidine group, a substituted or unsubstituted piperidine group, a substituted or unsubstituted pyrrolyl group, a substituted or unsubstituted pyrazolyl group, a substituted or unsubstituted imidazolyl group, or a substituted or unsubstituted benzimidazolyl group.

6. The additive of claim 1, wherein
the A, B, and C are each independently selected from the substituents listed in Group 1: 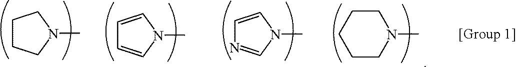
.

7. An electrolyte for a lithium secondary battery
a non-aqueous organic solvent,
a lithium salt, and
the additive according to claim 1.

8. The electrolyte for a lithium secondary battery of claim 7, wherein
the additive is included in an amount of 0.1 wt% to 10 wt% based on the total weight of the electrolyte for the lithium secondary battery.

9. The electrolyte for a lithium secondary battery of claim 7, wherein
the additive is included in an amount of 0.1 wt% to 5.0 wt% based on the total weight of the electrolyte for the lithium secondary battery.

10. The electrolyte for a lithium secondary battery of claim 7, wherein
the additive is included in an amount of 0.1 wt% to 3.0 wt% based on the total weight of the electrolyte for the lithium secondary battery.

11. A lithium secondary battery, comprising
a positive electrode including a positive electrode active material;
a negative electrode including a negative electrode active material;
the electrolyte of claim 7.

12. The lithium secondary battery of claim 11, wherein
the positive electrode active material is represented by Chemical Formula 4: 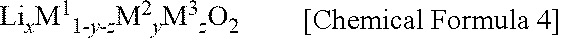
wherein, in Chemical Formula 4,
0.5≤x≤1.8, 0≤y≤1, 0≤z≤1, 0≤y+z<1, and M¹, M², and M³ each independently is any one selected from metals of Ni, Co, Mn, Al, Sr, Mg, or La, and a combination thereof.

13. The lithium secondary battery of claim 11, wherein
the positive electrode active material is a lithium composite oxide represented by at least one of Chemical Formula 4-1 to Chemical Formula 4-3: 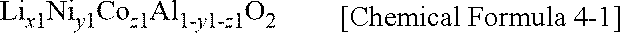
wherein, in Chemical Formula 4-1,
1≤x1≤1.2, 0<y1<1, and 0<z1 <1, 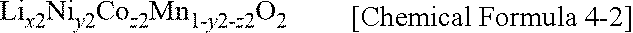
wherein, in Chemical Formula 4-2,
1≤x2≤1.2, 0<y2<1, and 0<z2<1, 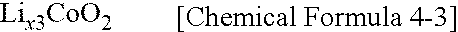
wherein, in Chemical Formula 4-3,
0.5< x3 ≤1.
